(19) United States
(12) Patent Application Publication
(10) Pub. No.: US 2025/0294617 A1
(43) Pub. Date: Sep. 18, 2025

(54) Supporting Multiple Timing for Multi-TRP Operation

(71) Applicant: Apple Inc., Cupertino, CA (US)

(72) Inventors: Haitong Sun, Cupertino, CA (US); Hong He, Cupertino, CA (US); Jie Cui, San Jose, CA (US); Dawei Zhang, Saratoga, CA (US); Wei Zeng, Saratoga, CA (US); Yushu Zhang, Beijing (CN); Chunxuan Ye, Cupertino, CA (US)

(21) Appl. No.: 18/860,384

(22) PCT Filed: Apr. 28, 2022
(86) PCT No.: PCT/CN2022/089947

§ 371 Date: Oct. 25, 2024

(51) Int. Cl. H04W 74/0833; H04W 76/38

(52) U.S. Cl. CPC H04W 74/0833; H04W 76/38

(57) ABSTRACT

Methods, apparatuses, and systems are disclosed for supporting multiple timing advance adjustments for multi-TRP (transmission and reception point) operation. Multiple TRPs may support a single serving cell, e.g., in support of a single component carrier (CC). A UE may receive at least one SSB from each of the TRPs, and may respond by transmitting at least one PRACH transmission via each TRP. Based on the reception timing of the PRACH transmissions, the serving cell may determine a respective timing advance (TA) value for use by the UE in connection with uplink transmissions for each respective TRP. The serving cell may communicate the TA values, and potentially subsequent updates thereto, to the UE. The serving cell may also provide configuration information to assist the UE in determining which TA to use for given uplink transmissions.

### PRIORITY INFORMATION

This application national stage entry of PCT Application No. PCT/CN2022/089947, entitled “Supporting Multiple Timing for Multi-TRP Operation,” filed Apr. 28, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for supporting multiple timing advance adjustments for multi-TRP operation.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, virtual reality, augmented reality, cloud gaming, and navigation using the global positioning system (GPS), and are capable of operating sophisticated applications that utilize these and other functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™ (BT), etc.

The ever-increasing number of features and functionality introduced in wireless communication devices also creates a continuous need for improvement in both wireless communications and in wireless communication devices. In particular, as UE devices improve to support additional functions, such as multi-TRP functionality, UEs and networks may experience increased timing complications. Accordingly, improvements in the field are desired.

### SUMMARY

Embodiments are presented herein of methods, apparatuses, and systems for supporting multiple timing advance (TA) values for multi-TRP operation.

For example, a base station of a wireless communication network may transmit to a user equipment (UE) a first synchronization signal block (SSB) via a first transmission and reception point (TRP); and transmit to the UE a second SSB via a second TRP, wherein the first SSB and the second SSB are transmitted on the same component carrier (CC). The base station may receive a first preamble random access channel (PRACH) transmission via the first TRP, the first PRACH transmission responsive to the first SSB; and may receive a second PRACH transmission via the second TRP, the second PRACH transmission responsive to the second SSB. The base station may determine a first timing advance (TA) value for use in the CC based on reception timing of the first TRP; and may determine a second TA value for use in the CC based on reception timing of the second TRP.

In some scenarios, the base station may provide to the UE an indication of the first TA value and an indication of the second TA value.

In some such scenarios, the indication of the first TA value and the indication of the second TA value may be transmitted to the UE within a single medium access control (MAC) control element (CE).

In some scenarios, the UE may be assigned to a first TA group (TAG) and a second TAG, and the first TA value may be associated with the first TAG, while the second TA value may be associated with the second TAG.

In some scenarios, the UE may be assigned to only one TA group (TAG), and both the first TA and the second TA may be associated with the one TAG.

In some scenarios, the base station may provide to the UE, within a second MAC CE, an indication of an adjustment to the first TA value and an indication of an adjustment to the second TA value. In some such scenarios, the indication of the adjustment to the second TA value may be expressed as a difference relative to the adjustment to the first TA value.

In some scenarios, the first PRACH transmission may be received during a first RACH occasion (RO) and the second PRACH transmission may be received during a second RO.

In some scenarios, the base station may provide to the UE a first RACH configuration for use in transmitting the first PRACH transmission and a second RACH configuration for use in transmitting the second PRACH transmission. The first PRACH transmission may be received in a first RACH occasion (RO) according to the first RACH configuration, and the second PRACH transmission may be received in the first RO according to the second RACH configuration.

In some such scenarios, the first RACH configuration and the second RACH configuration may include a same frequency domain allocation.

In some such scenarios, the first RACH configuration and the second RACH configuration may include a same time domain allocation.

As another example, an apparatus for use in a base station of a wireless communication network may include a memory medium storing software instructions; and processing circuitry configured to execute the software instructions. Executing the instructions may cause the apparatus to receive, via a first transmission and reception point (TRP), a first preamble random access channel (PRACH) message from a user equipment (UE); and receive, via a second TRP, a second PRACH transmission from the UE, wherein the first TRP and the second TRP are received on the same component carrier (CC). The apparatus may determine a first timing advance (TA) value for use in the CC based on reception timing of the first TRP; and determine a second TA value for use in the CC based on reception timing of the second TRP.

In some scenarios, the apparatus may provide to the UE a first RACH configuration for use in transmitting the first PRACH transmission and a second RACH configuration for use in transmitting the second PRACH transmission. The first PRACH transmission may be received in a RACH occasion (RO) according to the first RACH configuration, and the second PRACH transmission may be received in the RO according to the second RACH configuration.

As another example, a user equipment (UE) may receive a first synchronization signal block (SSB) from a first transmission and reception point (TRP) and receive a second SSB from a second TRP, wherein the first TRP and the second TRP support a same serving cell. The UE may transmit a first PRACH transmission to the first TRP, wherein the first PRACH transmission is responsive to the first SSB; and transmit a second PRACH transmission to the second TRP, wherein the second PRACH transmission is responsive to the second SSB. The UE may receive from the serving cell an indication of a first TA value determined based on timing of the first PRACH transmission and an indication of a second TA value determined based on timing of the second PRACH transmission.

In some scenarios, the UE may transmit a first uplink transmission to the first TRP, wherein the timing of the first uplink transmission is adjusted by the first TA value; and transmit a second uplink transmission to the second TRP, wherein the timing of the second uplink transmission is adjusted by the second TA value.

In some scenarios, the indication of the first TA value and the indication of the second TA value may be received within a first medium access control (MAC) control element (CE). In some such scenarios, the method of claim 16, wherein the UE is assigned to a first TA group (TAG) and a second TAG, and wherein the first TA value is associated with the first TAG and the second TA value is associated with the second TAG.

In some scenarios, the UE may receive, from the serving cell, sounding reference signal (SRS) configuration information indicating whether the first TA or the second TA is to be used for an SRS transmission utilizing resources of a first SRS resource set.

In some scenarios, the UE may receive from the serving cell a first RACH configuration for use in transmitting signals to the first TRP and a second RACH configuration for use in transmitting signals to the second TRP. The UE may transmit the first PRACH transmission in a first RACH occasion (RO) according to the first RACH configuration; and transmit the second PRACH transmission in the first RO according to the second RACH configuration.

In some such scenarios, the UE may determine a first transmit power level that is an appropriate transmit power for the first PRACH transmission based on a pathloss estimate of at least the first SSB; and determine a second transmit power level that is an appropriate transmit power for the second PRACH transmission based on a pathloss estimate of at least the second SSB. In response to determining that a sum of the first transmit power level and the second transmit power level exceeds a maximum transmit power limit for the UE, the UE may transmit the first PRACH transmission with the first transmit power level and transmit the second PRACH transmission with a third transmit power level that is less than the second transmit power level, wherein a sum of the first transmit power level and the third transmit power level is no greater than the maximum transmit power limit for the UE.

Apparatuses and memory media are disclosed for performing any of the preceding methods.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments; and

FIGS. 5A through 5C illustrate examples of scheduling RACH occasions in response to received synchronization signal blocks, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
DCI: Downlink Control Information
EUTRA: Evolved UMTS Terrestrial Radio Access.
FDM: Frequency Division Multiplexing
GSM: Global System for Mobile Communication
LTE: Long Term Evolution
MAC: Medium Access Control
MAC-CE: MAC Command Element
NR: New Radio
PRACH: Preamble Random Access Channel
PUCCH: Physical Uplink Control Channel
PUSCH: Physical Uplink Shared Channel
QCL: Quasi-Colocation
RACH: Random Access Channel
RAT: Radio Access Technology
RE: Resource Element
RF: Radio Frequency
RO: RACH Occasion
RX: Reception/Receive
SRS: Sounding Reference Signal
SSB: Synchronization Signal Block
TA: Timing Advance.
TAG: Timing Advance Group
TDM: Time Division Multiplexing
TRP: Transmission and Reception Point
TX: Transmission/Transmit
UE: User Equipment
UMTS: Universal Mobile Telecommunication System

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non- transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), virtual/augmented reality devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

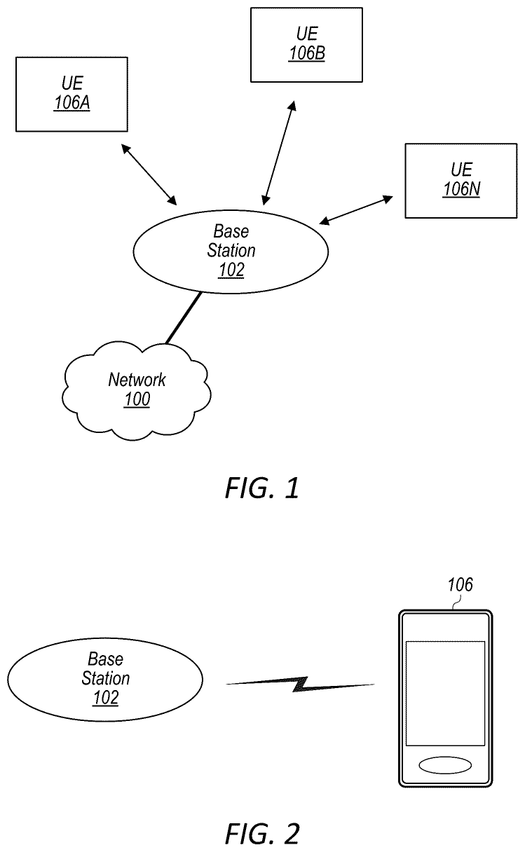

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an “eNodeB” or “eNB”. If the base station 102 is implemented in the context of 5G NR, it may alternately be referred to as a “gNodeB” or “gNB”. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to support multiple timing advance adjustments for multi-TRP operation, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, a virtual/augmented reality device, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

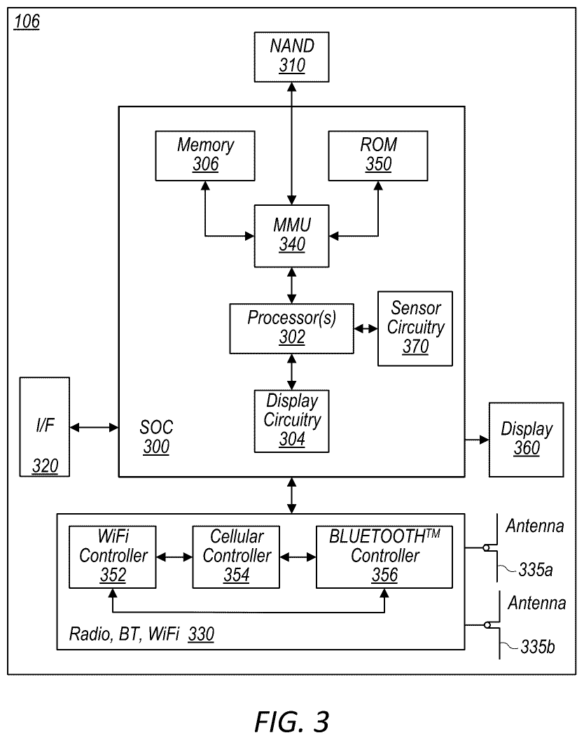

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. In some implementations, the display 360 may include a touchscreen capable of detecting user input, e.g., as touch events. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector interface (I/F) 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to support multiple timing advance adjustments for multi-TRP operation, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to support multiple timing advance adjustments for multi-TRP operation according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE, LTE-A, and/or NR controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

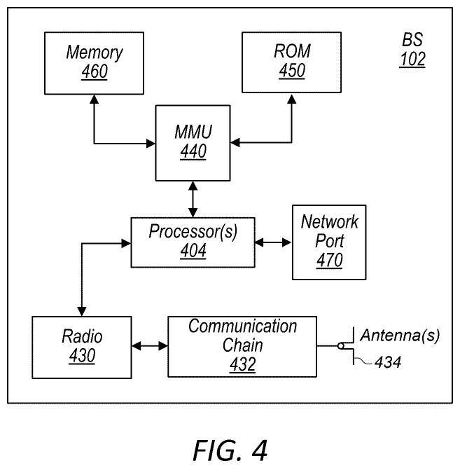

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE device 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

### Problem Statement

When a UE, such as the UE 106, transmits to a base station, such as the base station 102, the transmitted signal is received by the base station after a propagation delay that varies depending on the propagation distance. This propagation delay could potentially disrupt reception timing at the base station. For example, if different propagation delays of signals transmitted by different UEs cause timing differences greater than the length of a signal's cyclic prefix (CP), then two signals sent at different times, but received at overlapping times may interfere with each other. To avoid such timing problems, the UE may apply a timing advance (TA). Specifically, the UE may adjust its transmission time by the value specified by the TA, thereby transmitting the signal early enough to account for the propagation delay, such that the signal is received by the base station at the expected time, within the variation window accommodated by the CP.

For each UE with which the base station is communicating, the base station may determine an appropriate TA and communicate the determined TA to the respective UE. The base station may update the TA value as appropriate, e.g., as the UE moves, causing the propagation delay to change.

When using carrier aggregation (CA), a UE may be in communication with multiple base stations. Because the propagation delay to each base station may be different, the UE may receive a different TA from each base station. For example, the UE may receive a first TA from a first base station for use in transmission on one or more component carriers (CCs) supported by the first base station, and may receive a second TA from a second base station for use in transmission of one or more CCs supported by the second base station.

Because maintaining multiple TAs can be burdensome to a UE, it is not practical to maintain a separate TA for every serving cell. Therefore, serving cells having the same TA may be grouped as a TA group (TAG). For example, multiple CCs supported by a single base station may be included in a single TAG. Because the CCs are supported by the same base station, their reception timing would be synchronized and their propagation delays would be substantially similar, allowing use of the same TA.

Historically, each UE may have been required to handle at most one TA per CC. However, recent advancements in support for multiple transmission and reception points (TRPs) within a single CC may encourage support for multiple TAs within such a CC. Specifically, two TRPs with which the UE is communicating may not be colocated, and may therefore experience different propagation delays. Additionally, the two TRPs may not be perfectly time synchronized. These factors may lead to reception timing errors exceeding the CP. Thus, it may be advantageous to separately adjust the reception timing of multiple TRPs used within a single CC, e.g., by applying distinct TAs.

This desire to support multiple TAs within a single CC introduces significant technical obstacles. For example, technical problems to be considered include how a base station of a serving cell will estimate multiple TAs for the multiple TRPs, how the base station will indicate to the UE which TA to use for a given transmission, and how the base station will communicate initial and updated values of the multiple TRPs to the UE without unduly increasing control overhead.

### RACH Transmission for TA Estimation

TA estimation is typically based on random access channel (RACH) transmission. Specifically, each RACH operation performed by a UE is associated with a downlink signal, such as a synchronization signal block (SSB), which may be used by the UE to determine related UL information, such as power control information and/or beam selection information, and which may also be used to determine RACH transmission timing. The UE may transmit a preamble RACH (PRACH) message (e.g., msg1 or msgA) without applying a TA. Upon receiving the PRACH message, the base station may determine the timing of the received PRACH message relative to the associated downlink message to determine a timing offset. The base station may then determine a TA based on that timing offset. The base station may communicate the TA to the UE, and the UE may apply the TA to subsequent uplink transmissions, such as physical uplink shared channel (PUSCH) transmissions, physical uplink control channel (PUCCH) transmissions, and sounding reference signal (SRS) transmissions.

If multiple TAs are to be used by a UE in order to support Multi-TRP or Multi-Panel operation within a single CC, then further enhancement is needed, to allow determination of the multiple TAs by the single associated serving cell.

In general, when PRACH transmission timing is determined by a UE based on SSB reception timing (or other downlink message or reference signal timing), each SSB (or other downlink message or reference signal) may be transmitted from a single TRP. However, if the UE receives multiple SSBs within a single CC, they may potentially be received from different TRPs supporting a single serving cell. The UE may expect to receive only one downlink timing based on a single TRP.

In some implementations, the UE may transmit a plurality of PRACH messages pointing to different TRPs, within a single CC. For example, a first PRACH transmission (e.g., a first msg1 or msgA), pointing to a first TRP, may be used by a base station to determine a first TA for use by the UE when transmitting to the first TRP, wherein the transmission timing of the first PRACH transmission is based on a first SSB, transmitted by the first TRP. A second RACH transmission (e.g., a second msg1 or msgA), pointing to a second TRP, may be used by a base station to determine a second TA for use by the UE when transmitting to the second TRP, wherein the transmission timing of the second PRACH transmission is based on a second SSB, transmitted by the second TRP.

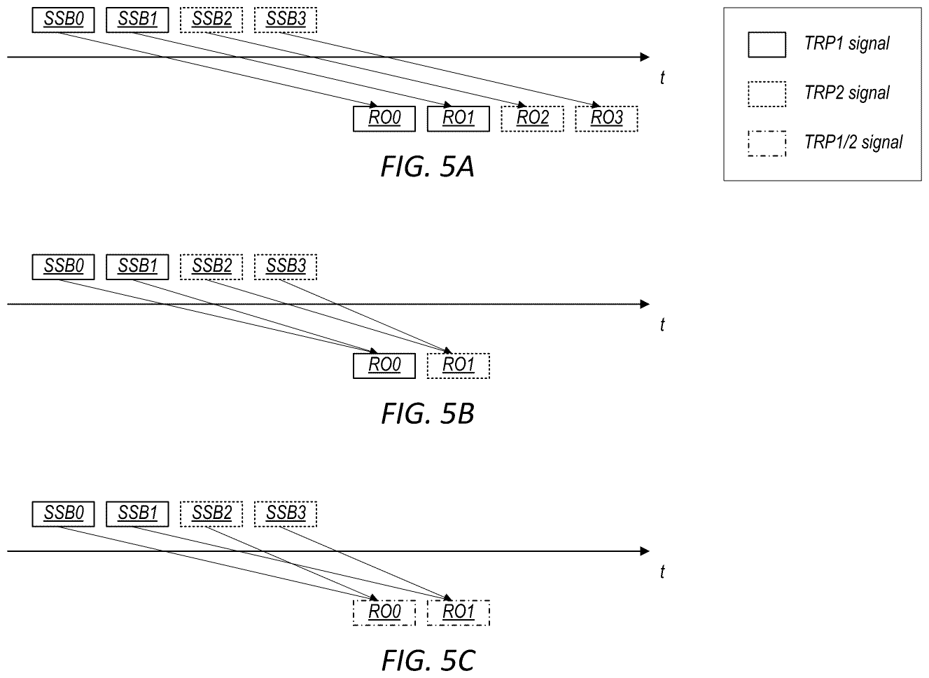

In some implementations, this may be implemented using RACH occasions (ROs). FIGS. 5A-5C illustrate various examples using ROs.

FIG. 5A illustrates an example in which a UE may transmit a respective RO in response to each received SSB. As illustrated in the example illustrated in FIG. 5A, the UE may receive SSB0 and SSB1 from TRP1. For example, SSB0 may utilize a first beam and SSB1 may utilize a second beam. The UE may further receive SSB2 and SSB3 from TRP2, e.g., each utilizing a respective beam. All four SSBs may be received within a single CC. In response to each SSB, the UE may transmit a respective associated RO. Each RO may be transmitted to the TRP from which the associated SSB was received. Specifically, in the example of FIG. 5A, RO0 is associated with SSB0, and is therefore transmitted to TRP1. RO1 is associated with SSB1, and is therefore also transmitted to TRP1. RO2 and RO3 are associated with SSB2 and SSB3, respectively, and are therefore both transmitted to TRP2.

Each of the illustrated ROs may include a respective PRACH, which may be used to determine a TA for use by the UE in subsequent transmissions to the applicable TRP. Specifically, in the example of FIG. 5A, a first TA, for use by the UE in transmitting subsequent signals to TRP1, may be determined using the timing of the received PRACH signal(s) of RO0 and/or RO1. The first TA may be determined by a base station, e.g., by a base station of the serving cell. Similarly, a second TA, for use by the UE in transmitting subsequent signals to TRP2, may be determined using the timing of the received PRACH signal(s) of RO2 and/or RO3. The second TA may be determined by a base station, e.g., by a base station of the serving cell.

FIG. 5B illustrates an example in which a UE may transmit a single RO in response to a plurality of SSBs received from a single TRP. As illustrated in FIG. 5B, the UE may again receive SSB0 and SSB1 from TRP1 (e.g., utilizing respective beams), and may further receive SSB2 and SSB3 from TRP2 (e.g., utilizing respective beams). All four SSBs may be received within a single CC. In response to receiving SSB0 and/or SSB1, the UE may transmit RO0 to TRP1. The transmit timing of RO0 may be associated with either SSB0 or SSB1, as long as the association is known to the base station that will determine the associated TA. Similarly, in response to receiving SSB2 and/or SSB3, the UE may transmit RO1 to TRP2. The implementation of FIG. 5B may reduce system overhead relative to the implementation of FIG. 5A, by reducing the number of ROs. For example, a single RO could be transmitted for each TRP, regardless of the number of SSBs received from a given TRP.

FIG. 5C illustrates an example in which a UE may transmit an RO in response to receiving multiple SSBs from multiple TRPs. As illustrated in FIG. 5C, the UE may again receive SSB0 and SSB1 from TRP1, and may further receive SSB2 and SSB3 from TRP2. However, the UE may transmit RO0 based on SSB0 (from TRP1) and SSB2 (from TRP2). Similarly, the UE may transmit RO1 based on SSB1 (from TRP1) and SSB3 (from TRP2). For example, in some implementations, RO0 may be associated with a first beam utilized by each TRP, and RO1 may be associated with a second beam utilized by each TRP.

In this example, the base station may be required to perform blind detection to determine the TRP(s) to which the RO applies. At RO0, a base station may instruct both TRP1 and TRP2 to detect the RACH. The base station may determine which TRP(s) was(were) addressed in the RO based on which TRP(s) successfully detects the RACH.

In some implementations of the example of FIG. 5C, multiple RACH configurations may be used within a single RO, to allow the base station to differentiate multiple PRACH transmissions within the single RO. For example, the RO may include a first PRACH transmission having a first RACH configuration, and logically mapped to the first TRP. The RO may also include a second PRACH transmission having a second RACH configuration, and logically mapped to the second TRP. In this way, the base station may be able to determine TA values for both TRPs based on the single RO.

The first and second RACH configurations may differ in RACH time domain allocation, frequency allocation, RACH sequence root, and or circular shift. For example, if the UE is capable of simultaneous transmission, then the UE may transmit two PRACH sequences having distinct frequency allocations, and potentially with distinct sequence roots and/or circular shift values. Alternatively (e.g., if the UE is not capable of simultaneous transmission), or additionally, the UE may transmit two PRACH sequences having distinct time domain allocations. In this way, the base station may avoid blind decoding, based on knowledge of the RACH configuration logically mapped to each TRP. The RACH configurations may be configured by the base station and communicated to the UE, e.g., via semi-static RRC configuration messaging.

In other implementations, only one RACH configuration may be used for each RO. This may prevent the UE or the base station from differentiating between TRPs within the RO. Thus, such implementations may be most appropriate for the examples of FIG. 5A or FIG. 5B, in which all SSBs mapped to a given RO are transmitted from the same TRP.

When SSBs from different TRPs are mapped to the same RO, as in FIG. 5C, and different RACH configurations are configured for each TRP, the UE could utilize any of several different behaviors in transmitting one or more PRACH transmissions within a given RO.

As a first example, the UE may transmit only a single PRACH within each RO. This may be advantageous, e.g., when the RACH configurations define multiple PRACH transmissions with the same time domain allocation; i.e., according to a frequency division multiplex (FDM) arrangement. If the UE were to transmit two PRACH transmissions simultaneously according to such configurations, the two transmissions may interfere. The UE may therefore transmit only one, e.g., logically mapped to one TRP, despite the availability of multiple RACH configurations.

In such an example, the UE may determine the transmit power of the PRACH based on consideration of pathloss estimates of all of the SSBs associated with the RO. For example, in the scenario of FIG. 5C, the UE may determine the transmit power of the PRACH to be transmitted in RO0 based on the of pathloss estimate of SSB0 and the pathloss estimate of SSB2. E.g., the UE may select the lesser of the two pathloss estimates, or the greater of the two pathloss estimates, or the pathloss estimate of the SSB that is associated with the PRACH transmission. The timing used for the PRACH transmission may be based on the reception timing of the corresponding SSB; i.e., the SSB received from the TRP to which the PRACH is mapped.

As a second example, the UE may transmit a plurality of (e.g., two) PRACH transmissions within each RO, despite the RACH configurations defining multiple PRACH transmissions with the same time domain allocation; i.e., according to an FDM arrangement. This example may reduce latency relative to the first example, but may suffer from some level of interference between the two PRACH transmissions. Each PRACH transmission may be associated with a respective SSB and may be logically mapped to the TRP from which the associated SSB was received. The UE may determine the transmit power and timing of each PRACH transmission based on the associated SSB.

Because the transmit power is determined independently for each PRACH transmission within the RO, in some scenarios, the total determined power of the two (or more) PRACH transmissions may exceed a defined maximum transmit power limit for the UE. To prevent this, the UE may apply power scaling according to any available procedure. For example, the UE may reduce the transmit power of each PRACH transmission by the same scaling factor. As another example, the UE may transmit one PRACH transmission at full power (i.e., the full transmit power determined based on the associated SSB), and may scale down the remaining PRACH transmission(s) by a sufficient amount to meet the maximum transmit power limit. As yet another example, the UE may transmit one PRACH transmission at full power, and may drop the remaining PRACH transmission(s) (e.g., forego transmission of the remaining PRACH transmission(s)), e.g., because the remaining power budget available for the remaining PRACH transmission(s) is insufficient to expect successful reception. E.g., the UE may drop the remaining PRACH transmission(s) in response to determining that the remaining power budget is below a threshold value or below a threshold scaling factor. In some scenarios, the UE may further respond by transitioning to time division multiplexing (TDM) PRACH.

As a third example, the UE may transmit a plurality of (e.g., two) PRACH transmissions within each RO, when the RACH configurations define multiple PRACH transmissions with the same frequency domain allocation; i.e., according to a TDM arrangement. Each PRACH transmission may be associated with a respective SSB and may be logically mapped to the TRP from which the associated SSB was received. The UE may determine the transmit power and timing of each PRACH transmission based on the associated SSB. This example may therefor allow the base station to resolve timing for multiple TRPs based on a single RO, without signal interference between the plurality of PRACH transmissions. For example, in the scenario illustrated in FIG. 5C, RO0 may include a first PRACH transmission with transmit power and timing based on SSB0, and a second PRACH transmission with transmit power and timing based on SSB2.

When multiple PRACH transmissions are included within a single RO, either with TDM or FDM format, certain circular shift values of the RACH sequence may be prohibited, e.g., when two PRACH transmissions use the same root sequence. This is due to a known timing/frequency ambiguity issue occurring with the Chu sequence used for NR PRACH transmission. Specifically, the Chu sequence is designed to result in low correlation between overlapping signals having different circular shift values. However, when the frequency offset is large enough, e.g., due to high movement rate of a UE or a large initial frequency offset, a RACH sequence transmitted with a particular circular shift and timing can be mistakenly decoded as another RACH sequence with different circular shift and timing. This problem is exacerbated when transmitting two PRACH transmissions to different TRPs within the same RO. In a worst-case scenario, TRP2 may mistakenly receive a transmission intended for TRP1, based on false reception with incorrect timing and circular shift values.

To avoid this, the UE may be configured with a subset of the Chu sequences that are otherwise available for PRACH transmission; i.e., only a subset of circular shift values may be applied to the root sequence to obtain distinct sequences. Specifically, the UE may be configured to use a first set of sequences (or circular shift values) for PRACH transmissions mapped to TRP1 and a second set of sequences for PRACH transmissions mapped to TRP2. The two sets of sequences may be selected so as to exclude any possibly ambiguous combinations.

### TA Indication Enhancement

Once the base station has determined the appropriate TA for a UE to use in uplink transmissions to each TRP of a plurality of TRPs within a single CC, and has communicated the TA values to the UE, the base station may indicate to the UE which TA to use for a given uplink transmission. Uplink transmissions may include SRS transmissions, PUCCH transmissions, and/or PUSCH transmissions. The base station may use different signaling to indicate the appropriate TA for the UE to use for the different types of transmission.

A UE may be configured with up to 64 SRS resources. These SRS resources may be organized into up to four SRS resource sets, each set including up to 16 SRS resources. When supporting multiple TAs, SRS configuration may include an indication of which TA to use in an SRS transmission.

In some implementations, each SRS resource set may be configured with a single TA. E.g., the base station may associate a complete resource set with a particular TRP, and may therefore configure the UE to utilize the TA mapped to that TRP when transmitting via that associated SRS resource set. As one option, the base station may use new signaling to configure a particular SRS resource set with the TA. For example, the base station may allocate a new information element (IE) to explicitly indicate which TA the UE is to use when transmitting via the particular SRS resource set. As another option, the base station may include an indication of which TA to use within existing SRS resource set configuration signaling, such as the power control field pathlossReferenceRS.

In some implementations, the SRS resources may be configured on a per-resource basis. E.g., the base station may associate each SRS resource with a particular TRP, and may therefore configure the UE to utilize the TA mapped to that TRP when transmitting via that associated SRS resource. In such implementations, SRS resources within a single resource set may utilize different TAs, and may be used in uplink transmissions to different TRPs. As one option, the base station may use new signaling to configure a particular SRS resource with the TA. As another option, the base station may include an indication of which TA to use within existing SRS resource configuration signaling, such as the QCL configuration field spatialRelationInfo.

In some scenarios, a single SRS resource may be included in more than one SRS resource set. This introduces additional complexity when supporting multiple TAs. As a first option, the base station may configure a given SRS resource with only one TA, regardless of the number of resource sets that include that SRS resource. This implies that a particular SRS resource may not be included in two SRS resource sets that are associated with different TAs at the SRS resource set level. As another option, the base station may be allowed to configure an SRS resource to use a first TA when utilized as part of a first SRS resource set, and to configure the same SRS resource to use a second TA when utilized as part of a second SRS resource set.

The base station may also indicate to the UE which TA to use for PUCCH transmissions. A UE may be configured with up to 128 PUCCH resources. As a first option, the base station may expressly associate each PUCCH resource with one of the available TAs, e.g., on a per-resource basis. As another option, the base station may leverage existing signaling, which may be logically mapped to a particular TRP. For example, the PUCCH closed loop power control index (closedLoopIndex) may identify one of two closed loops for use by PUCCH resources. In scenarios in which two TRPs are supported, it may be expected that the two TRPs are likely to have different uplink channel conditions, such that the two closed loops are likely to be effectively allocated to the two TRPs, respectively. In such scenarios, the UE may therefore determine which of the two TAs to use for a particular PUCCH resource based on the value of closedLoopIndex for that particular PUCCH resource. As another example, the UE may determine which of the available TAs to use for a particular PUCCH resource based on a PUCCH pathloss reference signal for open loop power control (PUCCH-PathlossReferenceRS). It may be expected that a first pathloss reference will be indicated for the first TRP and a second pathloss reference will be indicated for the second TRP. Thus, the pathloss reference signal may serve as an appropriate indication of TRP, and thus of the TA to be used. As other, similar, examples, the UE may determine which of the available TAs to use for a particular PUCCH resource based on a CORESETPoolIndex value of the DCI used to schedule the PUCCH, or based on a PUCCH quasi-colocation (QCL) configuration (PUCCH-SpatialRelationInfo). Because the two TRPs may be expected to have different uplink channel conditions, beam directions, etc., any of these indicators may be effectively used as logical proxies for indicating the TRP to which the PUCCH transmission will be directed, and may therefore be used as a basis for the UE to determine which TA to use for the PUCCH transmission. In some scenarios, any of these indicators may be communicated by the base station to the UE within an RRC IE or in some other way, e.g., as known in the art.

The base station may use similar options to indicate to the UE which TA to use for PUSCH transmissions. As a first option, the base station may expressly associate each PUSCH with one of the available TAs. As another option, the base station may leverage existing signaling, which may effectively be logically mapped to a particular TRP. For example, the UE may determine which of the available TAs to use for a particular PUSCH resource based on QCL configuration information (such as an SRS resource indicator (SRI) or a unified transmission configuration indicator (TCI)), a PUSCH closed loop power control index (sri-PUSCH-ClosedLoopIndex), a PUSCH pathloss reference signal for open loop power control (sri-PUSCH-PathlossReferenceRS-Id), or a CORESETPoolIndex of the DCI used to schedule the PUSCH. In some scenarios, any of these indicators may be communicated by the base station to the UE within an RRC IE or in some other way, e.g., as known in the art.

### TA Adjustment Enhancement

Once the base station of the serving cell has determined the appropriate TA for a UE to use in uplink transmissions to each TRP of a plurality of TRPs within a single CC, the base station may communicate the determined TA values to the UE. Additionally, the base station may subsequently update the UE regarding changes in the TA value, e.g., resulting from motion of the UE, changes in channel conditions, etc.

Traditionally, a base station could provide to the UE a medium access control (MAC) control element (MAC CE) including a Timing Advance Command to incrementally adjust a TA value. Such a Timing Advance Command MAC CE may include a TAG identifier (e.g., a 2-bit field) and a small field (e.g., a 6-bit field) indicating a TA adjustment value. The size of the TA adjustment field may limit the magnitude of the adjustment that can be made to the TA value.

Traditionally, a base station could provide to the UE a MAC CE including an Absolute Timing Advance Command to provide an indication of a new value for a TA, rather than an adjustment to an old value. Such a MAC CE may include a larger field (e.g., a 12-bit field) to accommodate a full TA value.

Based on these communications, the UE may maintain a current TA value for use in uplink transmissions.

Providing support for multiple TAs by a serving cell (e.g., within a single CC) may introduce significant additional complexity. For example, the UE may maintain multiple current TA values. In some implementations, this may be relatively simple, e.g., where a serving cell may belong to multiple TAGs. In such implementations, the UE may associate each TA with a respective TAG. A TA value may be set or updated by a communication from the base station (e.g., a timing advance command or absolute timing advance command) identifying the associated TAG.

However, in other implementations, a serving cell may continue to be constrained to belonging to only a single TAG. In such implementations, multiple (e.g., two) TAs may be maintained for the single TAG. To allow the UE to separately maintain the multiple TAs, each TA may be further associated with an additional index that may effectively serve as a proxy to logically map to a respective TRP, much as discussed above in connection with identifying a TA for use in PUCCH or PUSCH transmission. For example, each TA may be associated with a closed loop power control index, a CORESETPoolIndex, or a physical cell ID (PCI). A TA may be set or updated by a communication from the base station identifying the associated TAG, where the communication also indicates the associated index value.

Providing support for multiple TAs by a serving cell may also introduce additional overhead in communicating TA values and adjustments to the UE. For example, allowing two TAs per serving cell may increase (perhaps as much as double) the total number of TAs being maintained. In some implementations, the maximum number of TAGs allowed by the system may also be increased, to accommodate the increased number of TAs and/or to accommodate various combinations of TAs within TAGs, e.g., in implementations in which multiple TAs may be maintained for a single TAG. Thus, transmitting a distinct MAC CE for each TAG, as traditionally done within the single-TRP context, may increase overhead to an impractical degree.

To address this issue, commands for setting or updating TA values (e.g., timing advance command MAC CE and/or absolute timing advance command MAC CE) may be modified to allow modification of multiple TAs within a single command (e.g., within a single MAC CE). For example, in an implementation in which a serving cell may belong (e.g., be assigned) to multiple TAGs, a MAC CE may provide TA values or adjustments for the multiple TAGs. As another example, in an implementation in which a serving cell may belong to only a single TAG, and in which multiple TAs are therefore maintained for the single TAG, a MAC CE may provide TA values or adjustments for the multiple TAs.

As a specific example, in an implementation supporting two TAs for a single serving cell, a timing advance command MAC CE may be modified so as to include two 6-bit fields, each including an indication of a TA adjustment value for a respective TA. In some implementations, the MAC CE may be further modified to include a second TAG ID, e.g., if the serving cell belongs to multiple TAGs. In some implementations, the second TA adjustment value field (and/or the second TAG ID field) may be optionally present. For example, a flag (e.g., a 1-bit field) in the MAC CE may indicate the presence of the second TA adjustment value field. This may be used to allow backward compatibility for UEs that do not support multiple TAs.

As another example, overhead may be further reduced by using a differential encoding for the second TA adjustment value field. For example, instead of independently indicating each TA adjustment value in a respective 6-bit field, the MAC CE may be modified to indicate the first TA adjustment value in a 6-bit field, and to indicate the second TA adjustment value as a difference relative to the first TA adjustment value. Changes in TA values often result from movement of the UE relative to the applicable TRPs. For this reason, TA values pertaining to two TRPs of a serving cell are often correlated, as motion of the UE may result in similar shifts relative to both TRPs. Therefore, expressing the second TA adjustment value as a difference relative to the first TA adjustment value may allow the second TA adjustment value to be expressed with less bits. For example, the MAC CE may be implemented to include a 4- bit field (or some other number of bits) for the second TA adjustment value, rather than a 6-bit field.

Similarly, in an implementation supporting two TAs for a single serving cell, an absolute timing advance command MAC CE may be modified so as to include two 12-bit fields, each including an indication of a TA value for a respective TA. In some implementations, the second TA value field may be optionally present. For example, a flag (e.g., a 1-bit field) in the MAC CE may indicate the presence of the second TA value field. This may be used to allow backward compatibility for UEs that do not support multiple TAs.

Again, overhead may be further reduced by using differential encoding for the second TA value field. For example, instead of independently indicating each TA value in a respective 12-bit field, the MAC CE may be modified to indicate the first TA value in a 12-bit field, and to indicate the second TA value as a difference relative to the first TA value. This may allow the second TA adjustment value to be expressed with less bits. For example, the MAC CE may be implemented to include an 8-bit field (or some other number of bits) for the second TA value, rather than a 12-bit field. However, this may be less successful in connection with an absolute timing advance command MAC CE than with an incremental timing advance command MAC CE, as the values of the absolute TAs may not be correlated.

In some implementations, the TA values and adjustments may be determined based on reception timings, e.g., as outlined above in connection with FIGS. 5A through 5C. For example, the serving cell may determine an initial TA value for a UE based on a PRACH transmission received from that UE. The serving cell may provide that initial TA value to the UE, e.g., using an absolute timing advance command MAC CE. The serving cell may subsequently determine an updated TA value based on the timing of one or more additional transmissions received from the UE, and may provide an adjustment to the initial TA value based on the updated TA value, e.g., via a timing advance command MAC CE.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method comprising:
by a base station of a wireless communication network:
transmitting to a user equipment (UE) a first synchronization signal block (SSB) via a first transmission and reception point (TRP);
transmitting to the UE a second SSB via a second TRP, different from the first TRP, wherein the first SSB and the second SSB are transmitted on the same component carrier (CC);
receiving a first preamble random access channel (PRACH) transmission via the first TRP, the first PRACH transmission responsive to the first SSB;
receiving a second PRACH transmission via the second TRP, the second PRACH transmission responsive to the second SSB;
determining a first timing advance (TA) value for use in the CC based on reception timing of the first TRP; and
determining a second TA value for use in the CC based on reception timing of the second TRP.

2. The method of claim 1, further comprising;
by the base station:
providing to the UE an indication of the first TA value and an indication of the second TA value.

3. The method of claim 2, wherein the indication of the first TA value and the indication of the second TA value are transmitted to the UE within a single medium access control (MAC) control element (CE).

4. The method of claim 3, wherein the UE is assigned to a first TA group (TAG) and a second TAG on the same CC, and wherein the first TA value is associated with the first TAG and the second TA value is associated with the second TAG.

5. The method of claim 3, wherein the UE is assigned to only one TA group (TAG), and wherein both the first TA and the second TA are associated with the one TAG.

6. The method of claim 3, further comprising:
by the base station:
providing to the UE, within a second MAC CE, an indication of an adjustment to the first TA value and an indication of an adjustment to the second TA value.

7. The method of claim 6, wherein the indication of the adjustment to the second TA value is expressed as a difference relative to the adjustment to the first TA value.

8. The method of claim 1, wherein the first PRACH transmission is received during a first RACH occasion (RO) and the second PRACH transmission is received during a second RO.

9. The method of claim 1, further comprising:
by the base station:
providing to the UE a first RACH configuration for use in transmitting the first PRACH transmission and a second RACH configuration for use in transmitting the second PRACH transmission, wherein the first PRACH transmission is received in a first RACH occasion (RO) according to the first RACH configuration, and the second PRACH transmission is received in the first RO according to the second RACH configuration.

10. The method of claim 9, wherein the first RACH configuration and the second RACH configuration include a same frequency domain allocation.

11. The method of claim 9, wherein the first RACH configuration and the second RACH configuration include a same time domain allocation.

12. An apparatus for use in a base station of a wireless communication network, the apparatus comprising:
a memory medium storing software instructions; and
processing circuitry configured to execute the software instructions to cause the apparatus to:
receive, via a first transmission and reception point (TRP), a first preamble random access channel (PRACH) message from a user equipment (UE);
receive, via a second TRP, a second PRACH transmission from the UE, wherein the first TRP and the second TRP are received on the same component carrier (CC);
determine a first timing advance (TA) value for use in the CC based on reception timing of the first TRP; and
determine a second TA value for use in the CC based on reception timing of the second TRP.

13. A method comprising:
receiving a first synchronization signal block (SSB) from a first transmission and reception point (TRP);
receiving a second SSB from a second TRP, different from the first TRP, wherein the first TRP and the second TRP support a same serving cell;
providing for transmission a first PRACH transmission to the first TRP, wherein the first PRACH transmission is responsive to the first SSB;
providing for transmission a second PRACH transmission to the second TRP, wherein the second PRACH transmission is responsive to the second SSB; and
receiving from the serving cell an indication of a first timing advance (TA) value determined based on timing of the first PRACH transmission and an indication of a second TA value determined based on timing of the second PRACH transmission.

14. The method of claim 13, further comprising:
providing for transmission a first uplink transmission to the first TRP, wherein the timing of the first uplink transmission is adjusted by the first TA value; and
providing for transmission a second uplink transmission to the second TRP, wherein the timing of the second uplink transmission is adjusted by the second TA value.

15. The method of claim 13, wherein the indication of the first TA value and the indication of the second TA value are received within a first medium access control (MAC) control element (CE).

16. The method of claim 15, wherein the method is performed by a UE that is assigned to a first TA group (TAG) and a second TAG on a single component carrier (CC), and wherein the first TA value is associated with the first TAG and the second TA value is associated with the second TAG.

17. The method of claim 13, further comprising:
receiving, from the serving cell, sounding reference signal (SRS) configuration information indicating whether the first TA or the second TA is to be used for an SRS transmission utilizing resources of a first SRS resource set.

18. The method of claim 13, further comprising:
receiving, from the serving cell, a unified transmission configuration indicator (TCI) indicating whether the first TA or the second TA is to be used for a particular physical uplink shared channel (PUSCH).

19. The method of claim 13, further comprising:
receiving from the serving cell a first RACH configuration for use in transmitting signals to the first TRP and a second RACH configuration for use in transmitting signals to the second TRP;
providing for transmission the first PRACH transmission in a first RACH occasion (RO) according to the first RACH configuration; and
providing for transmission the second PRACH transmission in the first RO according to the second RACH configuration.

20. The method of claim 19, further comprising:
determining a first transmit power level that is an appropriate transmit power for the first PRACH transmission based on a pathloss estimate of at least the first SSB;
determining a second transmit power level that is an appropriate transmit power for the second PRACH transmission based on a pathloss estimate of at least the second SSB;
in response to determining that a sum of the first transmit power level and the second transmit power level exceeds a maximum transmit power limit, transmitting the first PRACH transmission with the first transmit power level and transmitting the second PRACH transmission with a third transmit power level that is less than the second transmit power level, wherein a sum of the first transmit power level and the third transmit power level is no greater than the maximum transmit power limit.
